(19) United States
(12) Patent Application Publication
(10) Pub. No.: US 2008/0233248 A1
(43) Pub. Date: Sep. 25, 2008

(54) Animal Feed with Targeted Characteristics

(75) Inventors: Kevin J. Swenke, Dallas, TX (US); John E. Bauer, College Station, TX (US)

Correspondence Address: BAKER BOTTS L.L.P., 2001 ROSS AVENUE, SUITE 600, DALLAS, TX, 75201-2980, US

(73) Assignee: VetScience LLC, Dallas, TX (US)

(21) Appl. No.: 12/054,100

(22) Filed: Mar. 24, 2008

Related U.S. Application Data
(60) Provisional application No. 60/896,631, filed on Mar. 23, 2007.

(51) Int. Cl. A23K 1/16

(52) U.S. Cl. 426/231; 426/635; 426/648

(57) ABSTRACT

An animal feed includes a first amount of a plant-based supplement, a second amount of base animal food, and a composition of nutrient additives in an amount and composition calculated according to a modified nutrient profile associated with a mixture of the base animal food with the plant-based supplement at a set ratio of the second amount to the first amount. The plant-based supplement may include cooked pumpkin. Also, the composition of nutrient additives may include selected ones of choline, calcium, taurine, and L-Carnitine.

### TECHNICAL FIELD OF THE INVENTION

The present invention relates generally to veterinary science and more particularly to feeding animals a healthy diet.

### BACKGROUND OF THE INVENTION

Obesity is the most common nutritional disorder affecting many animals (such as dogs, cats, and other pets) in the United States. In fact, it has been estimated that up to 40% of dogs are overweight or obese. Obesity can be defined as an accumulation of excess body fat resulting in body weights of more than 15-20% of optimum. These conditions can potentially impair the health, quality of life, and life span of affected animals.

Some breeds of dogs such as Labrador Retrievers, Dachshunds, Miniature Schnauzers, Welsh Corgis, Cocker Spaniels, and Beagles seem to be genetically predisposed to excessive weight gain. Obese adult dogs are more likely to be diagnosed with hypothyroidism, diabetes mellitus, pancreatitis, or neoplasia. Other disease conditions that may be associated with obesity in dogs include hyperadrenocorticism, hypertension, circulatory problems, and decreased resistance to infection. Overweight dogs are also predisposed to joint and locomotor problems including osteoarthritis, ruptured cruciate ligaments, dyspnea and fatigue, impaired reproductive efficiency, and dystocia.

Weight gain occurs when the intake of calories is greater than the expenditure of calories. The primary cause of weight gain is excessive food intake and inadequate exercise. Other causes of weight gain include age and neutering as these are associated with a reduction of both metabolic rate and physical activity. Weight loss occurs when the intake of calories is less than the expenditure of calories.

### SUMMARY OF THE INVENTION

According to particular embodiments, a method for creating an animal feed supplement includes identifying a base animal food; determining a nutrient profile associated with the base animal food; using the nutrient profile to determine a modified nutrient profile associated with a mixture of the base animal food with a plant-based supplement, the mixture having a set ratio of base animal food to plant-based supplement; calculating a composition of nutrient additives based on the modified nutrient profile; and mixing the composition of nutrient additives with a set amount of the plant-based supplement, as discussed below.

According to other embodiments, an animal feed supplement includes a first amount of a plant-based supplement for mixing with a second amount of base animal food; and a composition of nutrient additives in an amount and composition calculated according to a modified nutrient profile associated with a mixture of the base animal food with the plant-based supplement at a set ratio of the second amount to the first amount, as discussed below.

Embodiments of the invention provide various technical advantages. These techniques can provide nutrients to animals in such a way so as to promote healthy weight loss or weight maintenance while reducing the perception of hunger. When fed according to instructions, an animal feed supplement may provide reduced caloric consumption to support weight loss or weight maintenance goals without depriving animals of important nutrients. Reducing the perception of hunger may also be important for long-term weight loss or weight maintenance goals. Moreover, various embodiments may provide an animal feed supplement with a palatable flavor that animals will enjoy. In the example of a plant-based supplement made from pumpkin, another advantage is that there is no need for any flavor additive.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is made to the following description, taken in conjunction with the accompanying drawings, in which:

FIG. 1 illustrates a combined animal feed that includes a base animal food, an animal feed supplement, and a label; and

FIG. 2 illustrates an exemplary label for the animal feed supplement.

### DESCRIPTION OF EXAMPLE EMBODIMENTS

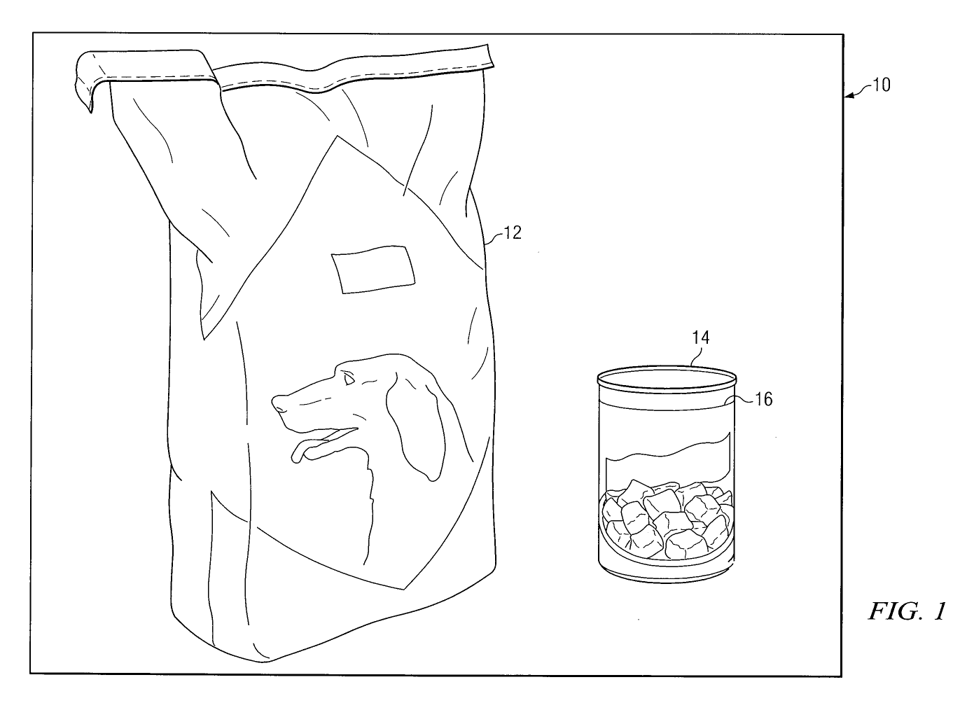

FIG. 1 illustrates a combined animal feed 10. In general, the sum of the components of a combined animal feed 10 provide a nutritionally adequate animal feed. As illustrated, the combined animal feed 10 includes a base animal food 12 and an animal feed supplement 14. While not illustrated, the combined animal feed 10 may also include any other suitable components to provide a nutritionally adequate animal feed.

Forming a combined animal feed 10 may include combining a base animal food 12 with an animal feed supplement 14 according to feeding instructions such that the combined animal feed 10 is nutritionally adequate. The feeding instructions may specify a ratio of base animal food 12 to animal feed supplement 14 or a particular amount of base animal food 12 and a particular amount of animal feed supplement 14 that should be combined to form the combined animal feed 10. Feeding instructions may depend upon feeding objectives. Examples of feeding objectives include weight loss and weight management.

According to particular embodiments, base animal food 12 may include a food, supplement, food component, treat, and/or other suitable food product. Base animal food 12 may comprise a commercially available animal food. Examples of commercially available animal food include the following: Hill's Science Diet® Light Adult; lams Weight Control™; Nutro Natural Choice® Lite; Pedigree Weight Maintenance™; Purina Beneful® Healthy Weight; and Purina® ONE® Healthy Weight Formula.

According to particular embodiments, animal feed supplement 14 may include a plant-based supplement and a composition of nutrient additives. In general, a plant-based supplement may be made from one or more fruits, vegetables, and/or other plants. More specifically, a plant-based supplement may be made from fruits, vegetables, and/or other plants that are naturally low in calories (in the range of less than 900 kcal/kg, 200-900 kcal/kg, 250-350 kcal/kg, 260-300 kcal/kg, or 279 kcal/kg of matter having more than 65% moisture according to the particular embodiment), low in crude fat (in the range of less than 4%, 0-4%, 0.1-2%, 0.15-1.5%, or 0.25% of matter having more than 65% moisture according to the particular embodiment), and high in crude fiber (in the range of greater than 1%, 1%-7%, 2%-5%, 2-3%, or 2.5% of matter having more than 65% moisture according to the particular embodiment). According to particular embodiments, a plant-based supplement may be made from plants that are naturally low in calories (in any of the ranges provided above, adjusted for matter having between 20% and 65% moisture or less than 20% moisture), low in crude fat (in any of the ranges provided above, adjusted for matter having between 20% and 65% moisture or less than 20% moisture), and high in crude fiber (in any of the ranges provided above, adjusted for matter having between 20% and 65% moisture or less than 20% moisture). An exemplary plant includes pumpkin. A composition of nutrient additives may include any suitable form or type of nutrients such as vitamins, minerals, proteins, and/or other nutrients that may be added to the plant-based supplement or added to the base animal food. To ensure that animals will eat animal feed supplement 14, it may have a palatable flavor. Animal feed supplement 14 may be in any suitable form, such as a pill, powder, tablet, liquid, gel, or mixture of solids and liquids. According to particular embodiments, animal feed supplement 14 is cooked, canned pumpkin with added nutrients. Animal feed supplement 14 may also be provided as a component of a nutritionally adequate commercially available animal feed, which may be offered in wet or dry form.

According to particular embodiments, an ideal goal for weight loss is approximately 1-2% of current body weight per week. This rate appears to help maximize the amount of adipose tissue loss while maintaining lean body mass. Even though a dog, cat, or other animal on a weight reduction program should receive a restricted amount of calories, they still need optimal amounts of other nutrients such as protein (especially high quality proteins having essential amino acids), vitamins, and minerals. Weight loss may actually increase the need for these nutrients, and thus the use of weight management or weight loss diets and/or supplements may be preferred.

According to particular embodiments, animal feed supplement 14 may contain particular nutrients that are shown in peer-reviewed scientific studies to promote healthy weight loss, support healthy metabolic body functions, or improve fat utilization. For example, animal feed supplement 14 may include dietary fiber, choline, calcium carbonate, taurine, and L-carnitine. Animal feed supplement 14 may also contain protein, fat, other nutrients, or other ingredients. Moreover, animal feed supplement 14 may include any suitable form of or alternative for particular nutrients. For example, rather than calcium carbonate, animal feed supplement 14 may include other forms of calcium, such as calcium periodate, calcium silicate, or calcium stearate. As another example, rather than choline, animal feed supplement 14 may include other forms of choline such as choline xanthate.

According to particular embodiments, combined animal feed 10 may provide a combined nutrient profile that meets or exceeds The Association of American Feed Control Officials' (AAFCO) requirements regarding at least a subset of nutrients. Nutritional adequacy of the combination may also be established through animal feeding trials in accordance with certain protocols (which may be set by The Association of American Feed Control Officials (AAFCO)) or by satisfying a nutrient profile (such as AAFCO's Nutrient Profiles). A nutrient profile specifies appropriate ranges for particular essential nutrients and may even specify appropriate ranges for particular nonessential nutrients. The nutrient profiles may depend upon a life stage. Examples of life stages include a maintenance stage and a growth and/or reproduction stage. In particular, AAFCO has established nutrient profiles for each of these life stages for dogs and for cats. AAFCO has historically recognized the National Research Council (NRC) as an authority on animal nutrition, especially with respect to the nutrient levels constituting a nutritionally adequate animal feed.

According to particular embodiments, animal feed supplement 14 may be designed, formulated, and developed to be fed together with prescribed amounts of a base animal food. In general, this combination, when fed according to instructions, may meet all nutritional needs for healthy weight loss or weight management. As an example of a feeding instruction, instead of feeding one cup of a particular commercially available animal food, feed ¾ cup of the commercially available animal food plus ¼ can (15 ounce can) of animal feed supplement 14. With respect to weight loss or weight management, combined animal feed 10 may provide calories to an extent at which weight loss or weight management will occur while allowing for a satiating volume of food to be consumed. Accordingly, feeding the combined animal feed 12 may prove to be a valuable strategy for long-term weight control.

According to particular embodiments, animal feed supplement 14 may contain dietary fiber. Increased amounts of dietary fiber may reduce the rate of digestion and absorption of nutrients and may increase the satiety in the dieting pet. Diets rich in dietary fiber are also naturally lower in calories on a per ounce basis. As such, they can provide the necessary calorie reduction for healthy weight loss and weight management while reducing a perception of hunger. Studies have shown that feeding obese dogs a higher fiber food resulted in reduced caloric consumption, reduced body weight, and a 3.3% reduction in body fat, whereas feeding a lower fiber food resulted in a comparable increase in caloric consumption and a 2.4% gain in body fat. These results suggest that the addition of dietary fiber to foods may be helpful in the treatment of canine obesity. Adding dietary fiber while ensuring that the remaining diet is not unbalanced may therefore be an important strategy for weight loss.

According to particular embodiments, animal feed supplement 14 may contain calcium carbonate. Calcium carbonate is a widely used dietary calcium supplement. Calcium carbonate in the food supplement may function as a vehicle for dispersing one or more other active nutrients contained in animal feed supplement 14. Calcium carbonate in the food supplement may also promote bone health. In addition, since some forms of dietary fiber may adversely affect calcium absorption in the gastrointestinal tract, calcium carbonate in animal feed supplement 14 may counteract this affect.

According to particular embodiments, animal feed supplement 14 may contain taurine 24. Taurine is an important sulfur amino acid in animals. Taurine's metabolic properties benefit various components of mammalian organ systems (such as the heart, kidney, and blood). Taurine may act as a catalyst facilitating the flow of ions needed to balance cell metabolism. For example, ions such as sodium, potassium, and calcium may depend on taurine to move from one cell to another. Although cats are best known for an absolute dietary requirement for taurine, recent studies have found that this amino acid can be beneficial to dogs as well. These features may be especially important to maintain heart health in animals on a reduced calorie diet.

According to particular embodiments, animal feed supplement 14 may contain choline 26. Choline is important in the synthesis of acetylcholine, a neurotransmitter, and phosphatidylcholine, which is important for cell membrane integrity. Choline is also important for hepatic lipoprotein synthesis, dispersal of fat from the liver, and, ultimately, utilization of fat by the body.

According to particular embodiments, animal feed supplement 14 may contain L-Carnitine 28. L-Carnitine is needed to transfer fatty acids across the intramitochondrial membrane of cells. It helps convert fat into energy and increases lean body mass. Because L-carnitine is essential in the process of converting fatty acids into energy, a deficiency may result in increased fat storage, decreased performance, and exacerbation of heart disease associated with mitochrondrial defects. L-Carnitine is involved in the regulation of fatty acid oxidation and increased dietary carnitine may improve fatty acid oxidative capacity in developing dogs. L-carntitine also appears to promote healthy weight loss in dogs. A study was conducted using overweight dogs fed similar diets. One group was given a diet supplemented with L-carnitine while another group received a diet without supplemental L-carnitine. After 7 weeks, the group that received the diet without supplemental L-carnitine lost 1.8% body weight compared to 6.4% body weight loss from the group that was fed the L-carnitine supplemented diet. Likewise, body fat was reduced in each group by 2.4% and 4.6%, respectively.

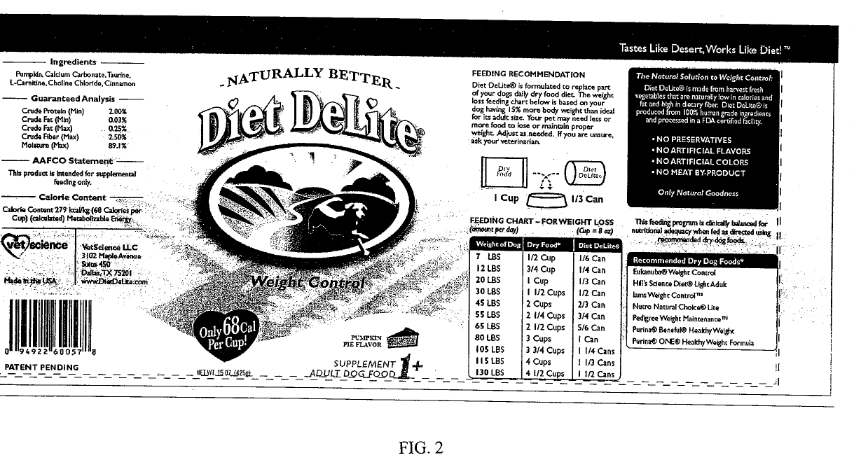

According to particular embodiments, animal feed supplement 14 may comprise a label 16. Label 16 may include one or more feeding instructions, which may be particularized according to feeding objectives. Label 16 may also include one or more nutrient profiles and may specify a particular life stage that the animal feed supplement supports. According to particular embodiments, a label 16 for animal feed supplement 14 may provide feeding instructions for weight loss based on an animal's starting obese body weight or based on the animal's ideal body weight. As a general rule, the ratio of ¾ cup animal food to ¼ can (15 oz can) of animal feed supplement 14 may be used when feeding for animals whose present body weights are not specifically indicated on label 16's feeding instructions. FIG. 2 illustrates an exemplary label for animal feed supplement 14. The exemplary label illustrates particular embodiments and is not all-inclusive. The label for animal feed supplement 14 may have any appropriate form and contents.

The above description with respect to FIG. 1 and FIG. 2 merely illustrates an example of a nutritionally adequate combined animal feed. The example explains particular embodiments and is not all-inclusive. While combined animal feed 10 is illustrated as having a particular combination of components, combined animal feed 10 may include any appropriate combination, separation, or distribution of components to provide the described functionality.

A method for creating an animal feed supplement may be described with respect to the following example. According to particular embodiments, a method for creating an animal feed supplement includes identifying a base animal food; determining a nutrient profile associated with the base animal food; using the nutrient profile to determine a modified nutrient profile associated with a mixture of the base animal food with a plant-based supplement, the mixture having a set ratio of base animal food to plant-based supplement; calculating a composition of nutrient additives based on the modified nutrient profile; and mixing the composition of nutrient additives with a set amount of the plant-based supplement, as discussed below. In this example of a method for creating an animal feed supplement, Table 1 (a-b) below illustrate example steps of identifying a base animal food and determining a nutrient profile associated with the base animal food. The method described with respect to Table 1 is merely illustrative. Table 1(a) below illustrates a nutrient profile associated with an exemplary identified base animal food (namely Purina One™ Healthy Weight Dog Food). Table 1(b) below illustrates a nutrient profile of a particular low-fat, low-calorie, and high-fiber plant (namely cooked canned pumpkin) obtained from the USDA database on nutrient composition of foods. While this disclosure addresses cooked canned pumpkin as an example of a low-fat, low-calorie, and high-fiber plant, any type of low-fat, low-calorie, and high-fiber plant may be used.

TABLE 1(a)
Sample: Purina ONE Healthy Weight

| | | Amount/ | Amount/ |
|---|---|---|---|
| Nutrients | Units | Cup | .75 Cup |
| Protein - Combustion | g | 26.34 | 19.8 |
| Fiber, Crude | g | 2.3 | 1.7 |
| Ash | g | 6.19 | 4.6 |
| Carbohydrates, Calculated | g | 44.33 | 33.2 |
| Calories, Calculated | Calories | 330 | 247.5 |
| Tryptophan | g | 0.26 | 0.2 |
| Cystine | g | 0.36 | 0.3 |
| Methionine | g | 0.54 | 0.4 |
| Aspartic Acid | g | 1.91 | 1.4 |
| Threonine | g | 0.94 | 0.7 |
| Serine | g | 1.2 | 0.9 |
| Glutamic Acid | g | 4.71 | 3.5 |
| Proline | g | 1.9 | 1.4 |
| Glycine | g | 1.61 | 1.2 |
| Alanine | g | 1.89 | 1.4 |
| Valine | g | 1.1 | 0.8 |
| Isoleucine | g | 0.92 | 0.7 |
| Leucine | g | 2.67 | 2.0 |
| Tyrosine | g | 0.83 | 0.6 |
| Phenylalanine | g | 1.29 | 1.0 |
| Lysine, Total | g | 1.22 | 0.9 |
| Histidine | g | 0.58 | 0.4 |
| Arginine | g | 1.36 | 1.0 |
| C18:2 Octadecadienoic (Linoleic) | g | 2.22 | 1.7 |
| Calcium | mg | 1230 | 922.5 |
| Copper | mg | 0.74 | 0.6 |
| Iodine - low levels | mg | 0.223 | 0.2 |
| Iron | mg | 29 | 21.8 |
| Magnesium | mg | 95 | 71.3 |
| Manganese | mg | 5 | 3.8 |
| Phosphorus | mg | 850 | 637.5 |
| Potassium | mg | 590 | 442.5 |
| Selenium | mcg | 70 | 52.5 |
| Sodium | mg | 280 | 210.0 |
| Zinc | mg | 21 | 15.8 |
| Chloride-Soluable | mg | 730 | 547.5 |
| Crude Fat by Acid Hydrolysis | g | 9.79 | 7.3 |
| Water | | | |
| Moisture by Vacuum Oven | g | 7.04 | 5.3 |
| Choline, Total | mg | 215 | 161.3 |
| Folic Acid, Total | mg | 0.594 | 0.4 |
| Niacin | mg | 20.9 | 15.7 |
| Pantothenic Acid | mg | 5.67 | 4.3 |
| Vitamin A, True - Retinol | iu | 1171 | 878.3 |
| Beta Carotene | iu | 75 | 56.3 |
| Total Vitamin A | iu | 1248 | 936.0 |
| Vitamin B1 - Thiamine Hdryochloride | mg | 4.74 | 3.6 |
| Vitamin B2 - Riboflavin | mg | 2.8 | 2.1 |
| Vitamin B6 | mg | 1.76 | 1.3 |
| Vitamin B12 | mg | 0.0142 | 0.0 |
| Vitamin D by HPLC | iu | 55.6 | 41.7 |
| Vitamin E (low level) | iu | 22.5 | 16.9 |
| Vitamin C | | | |
| Vitamin K | | | |
| taurine | | | |
| L-carnitine | | | |

TABLE 1(b)
Sample: Canned Pumpkin

| Nutrients | Units | Amount/Cup |
|---|---|---|
| Protein - Combustion | g | 2.7 |
| Fiber, Crude | g | 7.1 |
| Ash | g | 1.4 |
| Carbohydrates, Calculated | g | 19.8 |
| Calories, Calculated | Calories | 83.3 |
| Tryptophan | mg | 31.9 |
| Cystine | mg | 7.4 |
| Methionine | mg | 29.4 |
| Aspartic Acid | mg | 274 |
| Threonine | mg | 78.4 |
| Serine | mg | 118 |
| Glutamic Acid | mg | 495 |
| Proline | mg | 71 |
| Glycine | mg | 71 |
| Alanine | mg | 76 |
| Valine | mg | 93.1 |
| Isoleucine | mg | 83.3 |
| Leucine | mg | 125 |
| Tyrosine | mg | 113 |
| Phenylalanine | mg | 85.8 |
| Lysine, Total | mg | 147 |
| Histidine | mg | 41.7 |
| Arginine | mg | 145 |
| C18:2 Octadecadienoic (Linoleic) | | |
| Calcium | mg | 63.7 |
| Copper | mg | 0.3 |
| Iodine - low levels | | |
| Iron | mg | 3.4 |
| Magnesium | mg | 56.4 |
| Manganese | mg | 0.4 |
| Phosphorus | mg | 85.8 |
| Potassium | mg | 505 |
| Selenium | mcg | 1 |
| Sodium | mg | 12.3 |
| Zinc | mg | 0.4 |
| Chloride-Soluable | | |
| Crude Fat by Acid Hydrolysis | g | 0.7 |
| Water | | |
| Moisture by Vacuum Oven | g | 220 |
| Choline, Total | | |
| Folic Acid, Total | | |
| Niacin | mg | 0.9 |
| Pantothenic Acid | mg | 1 |
| Vitamin A, True - Retinol | mcg | 1906 |
| Beta Carotene | mcg | 38130 |
| Total Vitamin A | iu | 38130 |
| Vitamin B1 - Thiamine Hdryochloride | mg | 0.1 |
| Vitamin B2 - Riboflavin | mg | 0.1 |
| Vitamin B6 | mg | 0.1 |
| Vitamin B12 | | |
| Vitamin D by HPLC | | |
| Vitamin E (low level) | mg | 2.6 |
| Vitamin C | mg | 10.3 |
| Vitamin K | mcg | 39.2 |
| taurine | | |
| L-carnitine | | |

According to particular embodiments, development of an animal feed supplement may be based on the analyzed nutrient composition of a mixture of an identified base animal food with one or more low-fat, low-calorie, and high-fiber plants. In this example of a method for creating an animal feed supplement, the nutrient profile displayed in Table 1(a) may be used to determine a modified nutrient profile associated with a mixture of the base animal food with a plant-based supplement, the mixture having a set ratio of base animal food to plant-based supplement. The modified nutrient profile estimates the amount of each nutrient present in a particular combination of a commercially available animal food and a particular low-fat, low-calorie, and high-fiber plant (which, in this example, is cooked canned pumpkin). The modified nutrient profile may be based on the average nutrient content of the ingredients. The ratio of base animal food to plant-based supplement may be varied to provide the desired reduced caloric levels (based on the USDA nutrient database) and to promote healthy weight loss or weight management. The ratio of base animal food to plant-based supplement may be carefully chosen to achieve the reduced level of calories in order to achieve safe levels of weight loss or weight management. Based on this ratio, optimal amounts of base animal food and plant-based supplement may be chosen to meet AAFCO recommendations (except as noted below for iodine) for particular feeding scenarios. In this example, using the data and spreadsheets as described above, a ratio of base animal food to canned pumpkin was identified as 0.75 cup (8 oz measuring cup) of dog food to 0.25 can (15 oz can) supplemented, cooked, and canned pumpkin. While the method describes particular steps performed in a specific order, creating animal feed supplement 14 to be combined with a base animal food 12 contemplates adding any suitable collection and amounts of plant-based supplement and performing some, all, or none of these steps in any operable order.

According to particular embodiments, a method for creating an animal feed supplement includes calculating a composition of nutrient additives based on the modified nutrient profile and mixing the composition of nutrient additives with a set amount of the plant-based supplement. A sample mathematical spreadsheet may be designed and constructed to calculate a composition of nutrient additives based on the modified nutrient profile. The modified nutrient profile may be compared with dog food nutrient profiles published by AAFCO and the NRC. Based on these comparisons, mathematical constructs may be executed within a spreadsheet to determine the most appropriate combination. The manner of calculation, ratios, and amounts indicated in performing the calculations may be modified in any appropriate manner.

In this example, two nutrients, choline and iodine, recommended by AAFCO as necessary for a nutritionally adequate dog food product, were below their stated values to varying degrees in the theoretical blends. Note that this method may produce different deficiencies depending on the sample of animal feed used. In order to ameliorate the possibility of choline deficiency, it was decided that choline chloride would be added into the fresh pumpkin at the time of processing in order to increase its amount appropriately and meet or exceed the AAFCO recommendation. Choline is important in nerve tissue function and cell membranes. With regard to iodine, when the calculated values of the blends were compared with the 2006 Nutrient Requirements of Dogs and Cats from the National Academy of Science (2006 NRC) publication, all values were above the recommended allowance. In some cases, the total amount of iodine was slightly below the AAFCO amount. However, in no case was the iodine content below the 2006 NRC value. Thus additional iodine may not be needed in the formulation.

Two additional nutrients, not recognized as required but shown in the scientific literature to be of potential benefit to energy metabolism during weight loss, may also be added in amounts believed to be safe and efficacious during weight reduction. These two additional nutrients included taurine and L-carnitine. Amounts of these additional components were investigated and subsequently included in a pre-mix formulation that employed calcium carbonate as a carrier for the three added ingredients (choline chloride, taurine, and L-carnitine). The amount of additional calcium added to the combination was also checked to ensure that this nutrient was not excessive in the final blend. Calcium, taurine, and L-carnitine may be included as value added to support metabolism and energetics of dogs during weight loss.

According to particular embodiments, mixing the composition of nutrient additives with a set amount of the plant-based supplement may include a blending process. In this example of mixing pumpkin with a composition of nutrient additives, the composition of nutrient additives may be blended before the pumpkin is cooked and canned. This may be important given that fresh pumpkin is typically available only during limited harvesting windows, potentially only once per year.

In this example of a method for creating an animal feed supplement, Table 2(a) below illustrates an exemplary nutrient profile of an exemplary mixture of an exemplary composition of nutrient additives with a set amount of plant-based supplement. Table 2(b) below illustrates an exemplary nutrient profile of an exemplary animal feed comprising ¾ cup of Purina ONE™ Healthy Weight dog food and ¼ can of an animal feed supplement. The exemplary animal feed sample in Table 2(b) measures 77.53 grams (dry matter (“DM”)), calculated using the following calculation: (0.9267% DM×96 g/cup×0.75 cup Purina ONE™ Healthy Weight dog food)+(0.102% DM×106 g Diet Delight)=77.53 g DM.

TABLE 2(a)
Sample: Diet Delight

| | | | Amt/106 g |
|---|---|---|---|
| | | | or .25 can |
| Nutrients | Units | Amount/kg | (15 oz. can) |
| Protein - Combustion | g | 19.5 | 2.1 |
| Fiber, Crude | g | 23.0 | 2.44 |
| Ash | g | 7.1 | 0.75 |
| Carbohydrates, Calculated | g | 59.0 | 6.25 |
| Calories, Calculated | Calories | 279.0 | 29.57 |
| Tryptophan | mg | 0.32 | 0.03 |
| Cystine | mg | 0.24 | 0.03 |
| Methionine | mg | 0.29 | 0.03 |
| Aspartic Acid | mg | 2.13 | 0.23 |
| Threonine | mg | 1.11 | 0.12 |
| Serine | mg | 0.97 | 0.10 |
| Glutamic Acid | mg | 3.93 | 0.42 |
| Proline | mg | 0.86 | 0.09 |
| Glycine | mg | 0.43 | 0.05 |
| Alanine | mg | 0.79 | 0.08 |
| Valine | mg | 0.97 | 0.10 |
| Isoleucine | mg | 0.90 | 0.09 |
| Leucine | mg | 1.53 | 0.16 |
| Tyrosine | mg | 0.73 | 0.08 |
| Phenylalanine | mg | 0.61 | 0.06 |
| Lysine, Total | mg | 1.56 | 0.17 |
| Histidine | mg | 0.30 | 0.03 |
| Arginine | mg | 0.77 | 0.08 |
| C18:2 Octadecadienoic (Linoleic) | | | |
| Calcium | mg | 420 | 44.52 |
| Copper | mg | 1 | 0.13 |
| Iodine - low levels | | | |
| Iron | mg | 14 | 1.45 |
| Magnesium | mg | 228 | 24.13 |
| Manganese | mg | 2 | 0.17 |
| Phosphorus | mg | 346 | 36.71 |
| Potassium | mg | 2039 | 216.09 |
| Selenium | mcg | 4 | 0.43 |
| Sodium | mg | 50 | 5.26 |
| Zinc | mg | 2 | 0.17 |
| Chloride-Soluable | | | |
| Crude Fat by Acid Hydrolysis | g | 3 | 0.30 |
| Water | | | |
| Moisture by Vacuum Oven | g | 888 | 94.14 |
| Choline, Total | g | 300 | 31.80 |
| Folic Acid, Total | | | |
| Niacin | mg | 4 | 0.39 |
| Pantothenic Acid | mg | 4 | 0.43 |
| Vitamin A, True - Retinol | mcg | 7694 | 815.57 |
| Beta Carotene | mcg | 153921 | 16315.59 |
| Total Vitamin A | iu | 153921 | 16315.59 |
| Vitamin B1 - Thiamine | mg | 0 | 0.04 |
| Hdryochloride | | | |
| Vitamin B2 - Riboflavin | mg | 0 | 0.04 |
| Vitamin B6 | mg | 0 | 0.04 |
| Vitamin B12 | | | |
| Vitamin D by HPLC | | | |
| Vitamin E (low level) | mg | 10 | 1.11 |
| Vitamin C | mg | 42 | 4.41 |
| Vitamin K | mcg | 158 | 16.77 |
| taurine | | 1800.00 | 190.80 |
| L-carnitine | | 1000.00 | 106.00 |

TABLE 2(b)
Sample: .75 cup Purina ONE Healthy Weight + 0.25 can diet delight (15 oz can)

| | | | | AAFCO | |
|---|---|---|---|---|---|
| | | 77.5 g DM = .75 | Amount/ | Recommended | |
| Nutrients | Units | cup + .25 can | 100 g | Amount/100 g | Ratio |
| Protein - Combustion | g | 21.82 | 28.16 | 18 | 1.5643011 |
| Fiber, Crude | g | 4.16 | 5.37 | | |
| Ash | g | 5.40 | 6.96 | | |
| Carbohydrates, Calculated | g | 39.50 | 50.97 | | |
| Calories, Calculated | Calories | 277.07 | 357.51 | | |
| Tryptophan | g | 0.23 | 0.30 | 0.16 | 1.8452742 |
| Cystine | g | 0.30 | 0.38 | 0.43 | |
| Methionine + Cystine | | | | | 1.6884417 |
| Methionine | g | 0.44 | 0.56 | | |
| Aspartic Acid | g | 1.66 | 2.14 | | |
| Threonine | g | 0.82 | 1.06 | 0.48 | 2.2103118 |
| Serine | g | 1.00 | 1.29 | | |
| Glutamic Acid | g | 3.95 | 5.10 | | |
| Proline | g | 1.52 | 1.96 | | |
| Glycine | g | 1.25 | 1.62 | | |
| Alanine | g | 1.50 | 1.94 | | |
| Valine | g | 0.93 | 1.20 | 0.39 | 3.0683077 |
| Isoleucine | g | 0.78 | 1.01 | 0.37 | 2.7374926 |
| Leucine | g | 2.16 | 2.79 | 0.59 | 4.7329688 |
| Tyrosine | g | 0.70 | 0.90 | | |
| Phenylalanine | 9 | 1.03 | 1.33 | 0.73 | |
| Phenylalanine + Tyrosine | | | | | 2.7261845 |
| Lysine, Total | g | 1.08 | 1.39 | 0.63 | 2.2133702 |
| Histidine | g | 0.47 | 0.60 | 0.18 | 3.3447168 |
| Arginine | g | 1.10 | 1.42 | 0.51 | 2.7858065 |
| C18:2 Octadecadienoic | g | 1.67 | 2.15 | 1 | 2.1483871 |
| (Linoleic) | | | | | |
| Calcium | mg | 967.0 | 1247.77 | 600 | |
| Copper | mg | 0.68 | 0.88 | 0.73 | |
| Iodine - low levels | mg | 0.17 | 0.22 | 0.15 | |
| Iron | mg | 23.20 | 29.94 | 8-300 | |
| Magnesium | mg | 95 | 123.08 | 40-300 | |
| Manganese | mg | 3.92 | 5.06 | 0.5 | |
| Phosphorus | mg | 674 | 869.95 | 500 | |
| Potassium | mg | 659 | 849.79 | 600 | |
| Selenium | mcg | 53 | 68.29 | 11-200 | |
| Sodium | mg | 215 | 277.76 | 60 | |
| Zinc | mg | 15.92 | 20.54 | 12-100 | |
| Chloride-Soluable | mg | 547.5 | 706.45 | 90 | |
| Crude Fat by Acid | g | 7.6 | 9.86 | 5 | |
| Hydrolysis | | | | | |
| Water | | 0.0 | 0.00 | | |
| Moisture by Vacuum Oven | g | 99.4 | 128.28 | | |
| Choline | mg | 193.1 | 249.10 | 120 | |
| Folic Acid, Total | mg | 0.4 | 0.57 | 0.018 | |
| Niacin | mg | 16.1 | 20.72 | 1.14 | |
| Pantothenic Acid | mg | 4.7 | 6.04 | 1 | |
| Vitamin A, True - Retinol | iu | 1693.8 | 2185.57 | | |
| Beta Carotene | iu | 16371.8 | 21124.96 | none | |
| Total Vitamin A | iu | 17251.6 | 22260.12 | 500-25000 | |
| Vitamin B1 - Thiamine | mg | 3.6 | 4.64 | 0.1 | |
| Hdryochloride | | | | | |
| Vitamin B2 - Riboflavin | mg | 2.1 | 2.76 | 0.22 | |
| Vitamin B6 | mg | 1.4 | 1.76 | 0.1 | |
| Vitamin B12 | mg | 0.0 | 0.01 | 0.0022 | |
| Vitamin D by HPLC | iu | 41.7 | 53.81 | 50-500 | |
| Vitamin E (low level) | iu | 18.0 | 23.21 | 5-100 | |
| Vitamin C | | 4.4 | 5.69 | | |
| Vitamin K | | 16.8 | 21.64 | | |
| taurine | | 190.8 | 246.19 | | |
| L-carnitine | | 106.0 | 136.77 | | |

The method described with respect to Table 2 is merely illustrative. The manner of calculation, ratios, and amounts indicated in performing the calculations may be modified in any appropriate manner. While the method describes particular steps performed in a specific order, creating animal feed supplement 14 contemplates adding any suitable collection and amounts of nutrient additives and performing some, all, or none of these steps in any operable order.

In addition to the tables provided above to illustrate a particular example, additional spreadsheets may be constructed for other base animal foods using similar techniques to identify appropriate supplementation and ratios. While the above description describes particular steps performed in a specific order, mixing a base animal food with a plant-based supplement and a composition of nutrient additives contemplates mixing any suitable collections and amounts of animal food, supplements, and nutrient additives in any suitable ratio and performing some, all, or none of these steps in any operable order.

Since the present disclosure describes particular embodiments and suggests numerous alterations to one skilled in the art, the present disclosure encompasses all embodiments and alterations within the scope of the appended claims.

What is claimed is:

1. A method for creating an animal feed supplement comprising:
identifying a base animal food;
determining a nutrient profile associated with the base animal food;
using the nutrient profile to determine a modified nutrient profile associated with a mixture of the base animal food with a plant-based supplement, the mixture having a set ratio of base animal food to plant-based supplement;
calculating a composition of nutrient additives based on the modified nutrient profile; and
mixing the composition of nutrient additives with a set amount of the plant-based supplement.

2. The method of claim 1, wherein the plant-based supplement comprises plants having a caloric content between 200 kcal/kg and 400 kcal/kg, fat between 0 percent and 4 percent, and fiber between 1 percent and 7 percent.

3. The method of claim 1, wherein the plant-based supplement comprises plants having a caloric content of approximately 300 kcal/kg, fat of approximately 0.3 percent, and fiber of approximately 2 percent.

4. The method of claim 1, wherein the plant-based supplement comprises cooked pumpkin.

5. The method of claim 1, wherein the base animal feed comprises a commercially available animal feed.

6. The method of claim 1, wherein the composition of nutrient additives comprises choline.

7. The method of claim 1, wherein the composition of nutrient additives comprises at least one of calcium, taurine, and L-carnitine.

8. The method of claim 1, wherein a combination of the base animal feed, the plant-based supplement, and the composition of nutrient additives provides a combined nutrient profile that meets or exceeds The Association of American Feed Control Officials (AAFCO) requirements regarding at least a subset of nutrients.

9. An animal feed supplement comprising:
a first amount of a plant-based supplement for mixing with a second amount of base animal food; and
a composition of nutrient additives in an amount and composition calculated according to a modified nutrient profile associated with a mixture of the base animal food with the plant-based supplement at a set ratio of the second amount to the first amount.

10. The animal feed supplement of claim 9, wherein the plant-based supplement comprises plants having a caloric content between 200 kcal/kg and 400 kcal/kg, fat between 0 percent and 4 percent, and fiber between 1 percent and 7 percent.

11. The animal feed supplement of claim 9, wherein the plant-based supplement comprises plants having a caloric content of approximately 300 kcal/kg, fat of approximately 0.3 percent, and fiber of approximately 2 percent.

12. The animal feed supplement of claim 9, wherein the plant-based supplement comprises cooked pumpkin.

13. The animal feed supplement of claim 9, wherein the composition of nutrient additives comprises choline.

14. The animal feed supplement of claim 9, wherein the composition of nutrient additives comprises at least one of calcium, taurine, and L-carnitine.

15. The animal feed supplement of claim 9, wherein a combination of the base animal feed, the plant-based supplement, and the composition of nutrient additives provides a combined nutrient profile that meets or exceeds The Association of American Feed Control Officials (AAFCO) requirements regarding regarding at least a subset of nutrients.

16. An animal feed comprising:
a first amount of a plant-based supplement;
a second amount of base animal food; and
a composition of nutrient additives in an amount and composition calculated according to a modified nutrient profile associated with a mixture of the base animal food with the plant-based supplement at a set ratio of the second amount to the first amount.

17. The animal feed of claim 17, wherein the plant-based supplement comprises plants having a caloric content between 200 kcal/kg and 400 kcal/kg, fat between 0 percent and 4 percent, and fiber between 1 percent and 7 percent.

18. The animal feed of claim 17, wherein the plant-based supplement comprises plants having a caloric content of approximately 300 kcal/kg, fat of approximately 0.3 percent, and fiber of approximately 2 percent.

19. The animal feed of claim 17, wherein the plant-based supplement comprises cooked pumpkin.

20. The method of claim 1, wherein the composition of nutrient additives comprises choline.

21. The animal feed of claim 17, wherein the composition of nutrient additives comprises at least one of calcium, taurine, and L-Carnitine.

22. The animal feed of claim 17, wherein a combination of the base animal feed, the plant-based supplement, and the composition of nutrient additives provides a combined nutrient profile that meets or exceeds The Association of American Feed Control Officials (AAFCO) requirements regarding at least a subset of nutrients.
